(19) United States
(12) Patent Application Publication
(10) Pub. No.: US 2006/0259309 A1
(43) Pub. Date: Nov. 16, 2006

(54) Method and system for managing property cleaning services

(76) Inventor: Todd Pigott, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/126,849

(22) Filed: May 10, 2005

(51) Int. Cl. G06Q 99/00

(52) U.S. Cl. 705/1

(57) ABSTRACT

A method and system for managing property cleaning services that tracks work orders requesting cleaning services, such as specialty services and additional services, and customer complaints to ensure that the services and complaints are responded to in a manner consistent with company goals and objectives. With regard to customer complaints, the method and system has an automatic notification process whereby the work crews, company management and/or owners of the business and franchise are automatically notified if a complaint is not responded to or resolved in the time allotted for such responses and resolutions. The method and system improves customer satisfaction by improving the response to service requests and complaints and is particularly useful for improved oversight and control by a franchise owner of the franchisees that are providing cleaning services pursuant to the franchise brand so as to protect and enhance the value of that brand.

### CROSS-REFERENCE TO RELATED APPLICATIONS

None.

### BACKGROUND OF THE INVENTION

A. Field of the Invention

The field of the present invention relates generally to network-based methods and systems for overseeing, scheduling and verifying various activities associated with managing property, including buildings, facilities and the like. More particularly, the present invention relates to intranet/Internet methods and systems that are configured to improve customer service and support with regard to providing services that support or pertain to property management. Even more particularly, the present invention relates to such methods and systems that are specially adapted for providing improved customer service and quality control assurance with regard to property cleaning services.

B. Background

Many residents and businesses utilize cleaning services to clean their homes, offices, facilities, sites and other property so as to maintain the property in a clean, liveable and workable environment. Generally, but not exclusively, these cleaning services are hired on an independent contractor basis so as to relieve the individual property owner or manager of the responsibility to plan, schedule, follow-up and otherwise manage the cleaning service operations. The cleaning services typically have their own management staff who make contact with prospective customers, maintain relations with existing customers and manage the operations of the cleaning service, including the personnel who actually accomplish the various cleaning service tasks such as vacuuming, dusting, washing floors and windows, removing trash and replacing consumable supplies (i.e., toilet paper, light bulbs, etc.). In addition to providing standard or routine cleaning services, most cleaning service companies also provide or arrange for additional on-demand cleaning services that arise either periodically, such as thoroughly cleaning all the blinds, the parking lot surface or exterior windows, or which arise in response to an activity or incident, such as clean-ups that are necessary after a large party or particularly strong storm.

Although the direct contact with a cleaning company customer is typically with a particular contact person, such as an office manager, most business owners, officers or senior managers are at least indirectly involved in selecting, hiring and working with the company to provide property cleaning services. As is well known, the cleaning service company is generally selected based on factors such as their reputation for providing effective cleaning services and responding to customer requests and complaints, ability to provide the desired services, reliability of their cleaning crews and other personnel and the cost of their services. Once a particular cleaning company is selected and cleaning services are provided, the business contact person generally only needs to directly contact the cleaning company when special services are required or when it is necessary to complain about some forgotten or poorly done service. This typically arises by another employee of the business contacting the contact person to tell him or her of the need for additional services or to complain of some problem. The contact person then contacts the cleaning company owner or account manager, who then relays the information to the proper work crew member or members so that the additional services will be performed or the problem corrected. Unfortunately, if there are any questions regarding the additional service or problem, the information may have to go back through the various persons one or more additional times in order for the customer to obtain the service it wants. Needless to say, this can complicate matters and result in unhappy customers for the cleaning company.

With regard to larger properties, such as multi-floor buildings and office complexes, the property owner or manager is often the party who hires and coordinates the activities of the cleaning company. As a result, there is usually more than one tenant or business operator who has their office or offices cleaned and maintained by the cleaning services company hired by the property owner or manager. The need for additional services, whether requested by the building owner/manager or one of its tenants, or problems with the cleaning service also arise in these types of properties. The typical chain of responsibility when additional services are required or problems arise is that the individual tenant or business owner contacts the property owner/manager to inform it of the need for additional or special services, such as scheduling an extra or late cleaning for a company party or the replacement of light bulbs that are beginning to dim, or of any problems they have had or are having with the cleaning service that was performed, or supposed to be performed, as the case may be. The property owner/manager then contacts the cleaning service company account manager to inform him or her of the tenant's requests or concerns. The cleaning service management then passes this information on to the worker or workers who will be providing the services so that the action desired by the tenant or business operator will be addressed. Once the necessary or desired cleaning service is provided, the completed status information is often passed back from the worker through the cleaning services management personnel to the property owner or manager, who then passes that status on to the tenant or business operator. At times, however, the completed status information is not properly relayed back to the tenant or business operator. If the worker has any questions or needs some clarification as to the tasks he or she is to perform, this information and any responses to such questions/clarifications are passed back through this same, somewhat arduous chain of responsibility.

Many of the companies that provide cleaning services are rather small businesses where the owner of the business is directly involved in the cleaning operations, customer development and relations, work crew oversight and complaint resolution. As with other types of businesses, as a cleaning service company gets larger, with a greater number of customers and work crew employees, it becomes more and more difficult for the owner to have the proper operations, customer and employee oversight to ensure that a good product (i.e., the cleaning service) is being provided to its customers. As is well known in the business world, however, to develop value for the company and the brand under which it offers its cleaning service it is important for the owner of the business to maintain sufficient control of his or her business such that the company's brand becomes well known for providing quality services to its customers. One measure of how well a company performs is how effectively and efficiently it handles any requests for changes to the basic, routine service. For instance, a customer wants to have confidence that when it requests a special or additional service that the service is handled in the manner desired. As also well known, the need to provide quality cleaning services does not stop at the end of the actual service, but extends to the way the service company's management handles customer complaints, which will always arise no matter how much effort is placed on avoiding complaints. When a customer's complaint is handled in a manner that quickly responds to the customer and quickly and properly corrects or otherwise addresses the problem which was the source of the complaint, the customer is generally more understanding of the problem and can even be appreciative in the manner in which the complaint was addressed. Therefore, a very important aspect of any cleaning services business model is to provide for the quick response to and resolution of customer complaints. As is well known, unfortunately this aspect of the business is typically not considered and, as a result, not handled well.

As stated above, the ability of the owner to properly and effectively oversee a business becomes increasingly difficult as the business grows. This is particularly true with regard to franchise operations. While franchising a business such as a cleaning service business can have significant benefits to the owner, particularly with regard to geographical expansion, franchising also comes with certain difficulties and risks. One major difficulty is the franchise owner's ability to effectively oversee the franchisees so as to ensure that they are providing services in a manner that is consistent with the quality intended by the owner. Failure to maintain a consistent quality comes with substantial risk of harm to the brand value for the business. As is well known by franchise owners, one or more poorly run franchisees can put the value of the entire brand at risk. For instance, if a franchisee in a particular part of the state or country is so poorly operated that it develops a reputation for its poor service, this reputation can extend to the entire brand, thereby hurting franchisees in other parts of the state or country and, ultimately, potentially destroying the value of the brand to the franchise owner. As such, those who own or invest in a franchise operation based on the services which the franchisees will provide to customers, such as a cleaning services franchise where the services are of a somewhat local nature, expect and demand the franchise have some ability to effectively oversee and, as necessary, control the nature of the services provided by the franchisees, no matter how far away they provide those services from the franchise owner's location.

Despite the desire or even requirement to maintain oversight and control of one's franchisees in order to protect and develop the company's brand name, the typical manner in which the franchise owner oversees and controls its franchisees in the cleaning services industry is to do so, if at all, on an ad hoc type of basis. Generally, this involves asking the franchisee itself how it is doing or making telephone calls or sending out written questionnaires to customers of the franchisee to get some input from those customers. As is well known, however, these methods of overseeing the operations of franchisees are usually neither effective nor accurate. In fact, at most which can usually be determined is the customer's general “feel” for the franchisee's services instead of an accurate assessment of how well the franchisee is doing. One particular problem with such ad hoc or even periodic customer reviews is that specific complaints the customer had with the franchisee and how well those complaints were addressed may be forgotten by the customer when the franchise owner is seeking input. As such, the review is typically of little or no real help to the franchise owner when evaluating the quality of the franchisee or to the franchisee with regard to evaluating its own business operations so that it may provide a higher and more consistent level of service to its customers. In addition, there is typically no way for either the franchisee or franchise owner to know on an ongoing, real time basis how well and how quickly any customer's complaints are being handled by the managers and work crews who directly deal with the customers. For instance, it is not necessarily atypical for neither the franchisee nor the franchise owner to know whether a customer's complaint is being ignored until the customer terminates its service contract with the cleaning company, a result that is not desired by any of the affected parties.

A number of patents and published patent applications are directed to improved methods and systems for operating and overseeing business operations in service industries, including those in the property cleaning service industry. For instance, U.S. Pat. No. 6,216,108 to Le Vander discloses a business management system that is used to generate management reports for those in the service industry, including reports that utilize a variety of client and job parameters. U.S. Publication No. 2002/0138289 to Thielges discloses a system and method for managing property that includes the ability to initiate a request for a repair or other service and then tracking the performance and completion of the service by a vendor. U.S. Publication No. 2003/0036915 to Neumann discloses a method for quality assurance regarding the cleaning of a facility that can be used with a computerized system to provide a checklist type of analysis for inspection of the facility. U.S. Publications No. 2003/0065522 to Wepfer, 2003/0171970 to Kinsella and 2004/0044554 to Bull disclose various systems for managing, assigning and following-up on customer requested service orders and the like.

Although the prior art does disclose various methods and systems of generating work orders requested by the customer via a telephone or Internet based system, including some which pertain to the janitorial or cleaning service industries, none of the known prior art describe a method or system which is specifically effective for tracking work orders and customer complaints, ensuring that a response is timely made with regard to such work orders and complaints and providing the ability for management to oversee these aspects of the service. What is needed, therefore, is a method and system for managing property cleaning services that provides more effective oversight and control of the work order and customer complaint process for the managers and owners of property cleaning service companies, particularly those which are franchise operations. The preferred method and system should allow a customer to input a request for an additional service, a change in current services and any complaints that he or she has with regard to the cleaning services in a manner that ensures such requests, changes or complaints are acted upon in a timely and effective manner by the service company. The preferred method and system should allow the cleaning service company managers and owners to effectively track work orders and customer complaints and provide automatic management notification of customer complaints. The preferred method and system should be configured to improve customer complaint resolution by ensuring that the cleaning service company personnel most directly responsible for the customer are aware of any complaints and are following-up on resolving the complaints. The preferred method and system should notify cleaning company management when company goals and objectives with regard to customer complaint resolution are not met. The preferred method and system should be particularly useful for allowing franchise owners to monitor and control the customer response activities of their franchisees so as to protect and enhance the value of the franchise owner's brand.

### SUMMARY OF THE INVENTION

The method and system for managing property cleaning services of the present invention provides the benefits and solves the problems identified above. That is to say, the present invention discloses a method and system for managing property cleaning services that provides more effective oversight and control of the work order and customer complaint process for the managers and owners of property cleaning service companies, particularly those which are franchise operations and the like. The preferred method and system of the present invention allows customers to directly input any work order requests that they have with regard to special services, changes in their service or complaints pertaining to provided or not provided services into a database that then automatically directs this information to the cleaning service personnel who are most directly responsible for the particular customer. The preferred embodiment of the method and system of the present invention improves customer complaint resolution by notifying the cleaning service company personnel most directly responsible for the customer of any complaints and ensures that these personnel are following-up on resolving the complaints in a manner that is consistent with the cleaning company's goals and objectives with regard to customer complaint resolution. The preferred embodiment of the method and system of the present invention automatically notifies cleaning company management, which can include the franchisee owner and franchise owner, when these goals and objectives are not met. As such, the method and system of the present invention is configured to assist the franchise or other business owner in enhancing and protecting the company's valuable brand assets.

In the preferred embodiment of the present invention, the method of managing property cleaning services includes the step of providing a work order form for receiving a complaint or a request for services from a cleaning services customer. The work order form is preferably adapted for transmittal to a computer database configured in a central computer that is connected to a global information network so the cleaning services company franchisee, the franchise owner and any other authorized party can have access thereto. The complaint is entered into the work order form by the customer or a representative of the business order for those complaints or requests that are telephoned in and then stored in the computer database. The complaint is then transmitted by the central computer to one or more cleaning services company personnel, such as the responsible account manager and work crew. The account manager contacts the customer and prepares an action plan to resolve the complaint within a pre-set customer contact period. If the customer is not notified within the customer contact period, then the computer system automatically notifies one or more managers of the company of the delay in responding to the customer. Once the action plan is set, the work is then completed to resolve the customer's complaint. If the complaint is not resolved within a pre-set complaint resolution period, then the computer system automatically notifies one or more of the cleaning company managers, owner and the franchise owner of the failure to resolve the complaint in the allowed time. The computer system is preferably provided with a contact timer system that is configured to track the actual customer contact and complaint resolution time so that the performance of the cleaning services business can be reviewed by the business and/or franchise owner. The computer system can also track the cleaning services company responses to requests for services, such as specialty services and additional services.

In one embodiment of the system for managing property cleaning services of the present invention, the system includes a central computer and a computer database associated with the central computer that is configured for receiving a complaint generated by the customer and transmitting the complaint to one or more company personnel, such as the customer account manager and work crew. The system also comprises a variety of reports, such as a complaint report corresponding to the customer's complaint. The complaint report is prepared from data entered by either the customer via the Internet or by a representative of the cleaning service company for those complaints that are telephoned in by the customer. The complaint report is then transmitted to at least various company personnel for a response and preparation of an action plan. A contact verification report is prepared by the account manager after contacting the customer regarding the complaint and preparing the action plan to respond to the complaint. A resolution confirmation report confirms that the complaint has been addressed by the responsible account manager and work crew. A manager oversight report notifies a manager, the cleaning services company owner or franchise owner of the status of the complaint. Preferably, the manager oversight report is configured to automatically notify the manager if the contact verification report is not prepared within a pre-set customer contact period and/or if the resolution confirmation report is not accomplished within a pre-set complaint resolution period. In a preferred embodiment, the complaint report, contact verification report, action plan and resolution confirmation report are merged into a single management report. For use with a franchise arrangement, the computer database can be controlled by or at least accessible by the franchise owner so that he or she can oversee the operations of the cleaning services company franchisees to enhance and protect the value of the franchise brand.

Accordingly, the primary objective of the present invention is to provide a new method and system for managing property cleaning services that provides the advantages described herein and that overcomes the disadvantages associated with presently available methods and systems of managing property cleaning services.

It is also an important objective of the present invention to provide a method and system for managing property cleaning services that incorporates processes for tracking work orders and customer complaints to ensure that the work orders and complaints are followed-up by the appropriate company personnel in a manner that is consistent with company goals and objectives.

It is also an important part of the present invention to provide a method and system for managing property cleaning services that incorporates processes for communicating specialty services and changes in the services provided from sales to the appropriate company personnel.

It is also an important part of the present invention to provide a method and system for managing property cleaning services that incorporates processes for scheduling and tracking specialty services, particularly that specialty services may be scheduled on a periodic basis and processed into work orders with specific completion dates to be completed by the appropriate company personnel.

It is also an important objective of the present invention to provide a method and system for managing property cleaning services that has an automatic management notification process that notifies company management whenever a customer complaint is not followed-up in a timely and appropriate manner.

It is also an important objective of the present invention to provide a method and system for managing property cleaning services that improves a business owner's oversight of the quality of customer services provided by the employees of the business, particularly with regard to the customer complaint resolution process.

It is also an important objective of the present invention to provide a method and system for managing property that improves a business owner's oversight of the quality of customer services provided by the employees of the business, particularly with regard to the level of satisfaction of the customer with the services being provided.

It is also an important objective of the present invention to provide a method and system for managing property cleaning services that improves customer complaint resolution by automatically notifying the customer's account manager of the complaint so as to initiate a customer contact and begin the complaint resolution process and by automatically notifying management and/or the business owner if the customer contact or complaint resolution is not accomplished in a specified amount of time, as established by company policies and objectives.

It is also an important objective of the present invention to provide a method and system for managing property cleaning services that improves the ability of a franchise owner to maintain a greater level of oversight and control over franchisee operations, particularly with regard to providing improved access to and input into the customer complaint resolution process.

It is also an important objective of the present invention to provide a method and system for managing property that improves the ability of the cleaning service to communicate to the customer on a periodic basis information regarding the services performed.

The above and other objectives of the present invention will be explained in greater detail by reference to the attached figures and the description of the preferred embodiment which follows. As set forth herein, the present invention resides in the novel features of form, mode of operation and combination of processes presently described and understood by the claims.

### BRIEF DESCRIPTION OF THE DRAWINGS

In the drawings which illustrate the best modes presently contemplated for carrying out the present invention:

FIG. 1 is a block diagram of a method and system for managing property cleaning services in accordance with an embodiment of the present invention;

FIG. 2 is a block diagram showing the interconnection between the various computer systems used with the system of the present invention;

FIG. 3 is a customer data form screen for customer information in accordance with a preferred embodiment of the method and system of the present invention;

FIG. 4 is a customer data form screen for customer location information in accordance with a preferred embodiment of the method and system of the present invention;

FIG. 5 is a customer data form screen for customer work order summary information in accordance with a preferred embodiment of the method and system of the present invention;

FIG. 6 is a customer data form screen for customer contact information in accordance with a preferred embodiment of the method and system of the present invention;

FIG. 7 is a location data form screen for summarizing a location of a customer in accordance with a preferred embodiment of the method and system of the present invention;

FIG. 8 is a location data form screen for summarizing the services at a location for a customer in accordance with a preferred embodiment of the method and system of the present invention;

FIG. 9 is a flow chart illustrating a method and system for entering and handling work orders, including complaints and requests for services, in accordance with a preferred embodiment of the present invention;

FIG. 10 is a work order form screen for specialty and additional services in accordance with a preferred embodiment of the method and system of the present invention;

FIG. 11 is a work order form screen for a customer complaint in accordance with a preferred embodiment of the method and system of the present invention;

FIG. 12 is an account manager log for recording site visits in accordance with a preferred embodiment of the method and system of the present invention; and

FIG. 13 is a site survey form screen for reviewing a customer's property for use in accordance with a preferred embodiment of the method and system of the present invention;

FIG. 14 is a satisfaction report, shown as a screen display, that shows the average customer satisfaction rating per month; and

FIG. 15 is a complaint response and resolution report, shown as a screen display, that identifies average time of response/resolution and details on the various complaints.

### DETAILED DESCRIPTION OF THE PREFERRED EMBODIMENTS

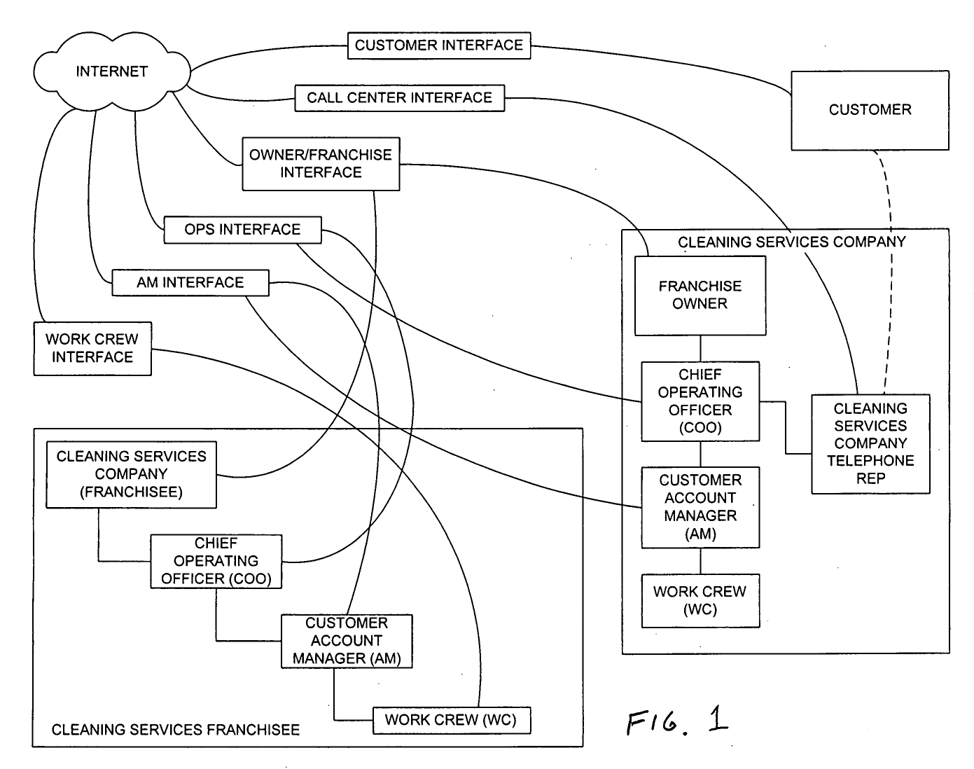

With reference to the figures where like elements have been given like numerical designations to facilitate the reader's understanding of the present invention, and particularly with reference to the embodiments of the present invention illustrated in FIGS. 1, 2 and 9, the preferred embodiments of the present invention are set forth below. The method and system of the present invention, identified generally as 10 in FIG. 1, is configured for managing property cleaning services provided to a customer 12 by a cleaning services company 14. Cleaning services are typically broken down into standard or routine cleaning services, such as vacuuming, dusting, washing floors and windows, removing trash and replacing consumable supplies (i.e., toilet paper, light bulbs, etc.), and into speciality services that arise periodically, such as thoroughly cleaning all the blinds, the parking lot surface or exterior windows, and additional services which typically arise in response to an activity or incident, such as clean-ups that are necessary after a large party or particularly strong storm. Generally, when the customer 12 enters into a cleaning contract with the cleaning services company 14 the scope of the routine cleaning is specified so the customer 12 knows what cleaning services to expect and the cleaning services company 14 knows what is expected of it to properly service the customer 12.

Most cleaning service companies 14 are generally relatively small businesses that arrange with one or more local customers 12 to clean the customer's property, including buildings, offices, manufacturing or production facilities and the like. Typically, such small businesses interact with the customer on an ad hoc type basis. If there is a problem or additional work is required, customer 12 typically calls the cleaning service company 14 to complain or request the additional work. As is well known, unfortunately this type of system does not always work very well and it is generally unworkable for any larger sized property cleaning companies 14, particularly those which are part of a franchise organization, shown as 16 in FIG. 1. The property cleaning services method and system 10 of the present invention is directed to improvements in the way the cleaning services company 14 interacts with the customer 12, particularly as to complaints that may arise with regard to the cleaning services provided by cleaning services company 14.

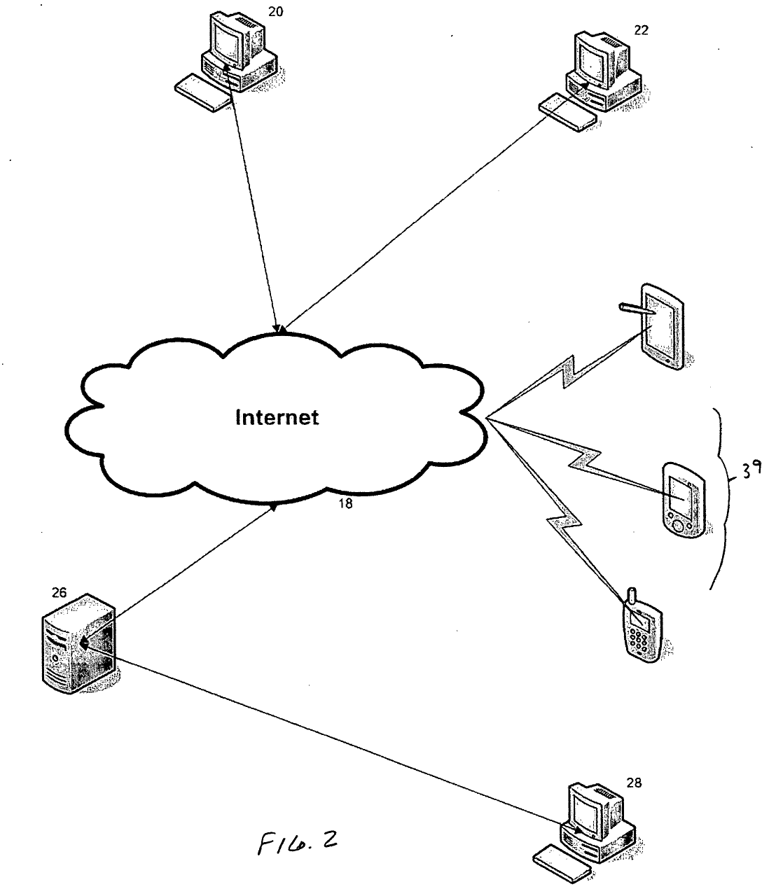

In a preferred embodiment, the system and method 10 of the present invention is adapted to work with a global information network, such as Internet 18, and with the customer's computer system 20 and the service company's computer system 22, as shown in FIG. 2. In the preferred embodiment of the system and method 10 of the present invention, franchise organization 16 comprises the franchise owner 24, or an entity that manages the franchise organization 16 on behalf of the franchise owner, that has a central computer 26 to which is connected the franchise owner's computer system 28. In the embodiment shown in FIG. 2, the central computer 26 is shown as being controlled, maintained and otherwise under the auspices of the franchise owner 24. In an alternative embodiment, in which there is no franchise organization 16, the cleaning services company's computer system 22 would function as the central computer 26 that would be connected to the customer's computer system 20 via Internet 18. In yet another embodiment, the cleaning services company's computer system 22 functions as the central computer 26 and the franchise owner's computer system 28 connects thereto. In any of these embodiments, system 10 can be configured such that various portable or hand-held devices, such as cellular telephones, PDAs and the like (shown collectively as 29 in FIG. 2) can access system 10 through the Internet 18 or by other wireless transmission mechanisms.

As shown in FIG. 1, the typical cleaning services company 14, whether a franchisee or a stand-alone company, comprises a number of company personnel, including one or more members of a management staff that includes a chief operating officer 30 (who may be the owner of the smaller business), one or more account managers 32 and one or more work crews 34. For purposes of this disclosure, the customer 12 is a business or other entity, including a unit within a company, that is receiving cleaning services from the cleaning services company or franchisee 14 at one or more locations owned or leased by the customer 12. The customer location is the customer's place of business or other physical site where cleaning services are provided. The cleaning services company 14 is that person or entity that provides cleaning services to the customer 12 and, when in the context of a franchisee, is that person or entity cleaning organization that is granted the right to provide cleaning services under the franchise owner's brands or trademarks. The chief operations officer or COO is that person responsible for managing the providing of cleaning services to customer 12 for franchisee 14 on behalf of the franchise organization 16. The account manager or AM 32 is that person who is responsible for providing customer services to a group of customers 12 and/or customer locations. The work crew or WC 34 comprises one or more employees or sub-contract personnel of cleaning services company or franchisee 14 who provide the cleaning services at a customer's location. A location is assigned to an account manager 32 and work crew 34. The franchise owner 24 is that person or entity that owns and/or manages the brand/trademark under which the cleaning services are provided to customer 12.

One of the major concerns with regard to any business is the ability to have oversight and control with regard to the work its employees perform and any interaction they may have with a customer 12, particularly if that interaction is in the nature of a complaint. This concern is particularly an issue for franchise organizations 16 with regard to its ability to have oversight and control over the individual cleaning service company franchisees 14 that make up the franchise organization 16. To improve such oversight and control, the method and system 10 of the present invention utilizes an interconnected computer system that records information into a central computer 26, as shown in FIG. 2, for use and review by the franchise owner 24. In the other embodiment, computer system 22 of each franchisee 14 can receive and store the information pertinent to its operations and franchise owner 24 has the ability to access the computer data stored therein via Internet 18 and/or the relevant information can be transmitted via Internet 18 to the franchise owner's computer system 28. As well known within the art, customer's computer system 20, franchisee's computer system 22 and/or franchise owner's computer system 28 can comprise a single stand alone computer or an intranet or other local area network that interconnects a number of computers together at the respective entity's site.

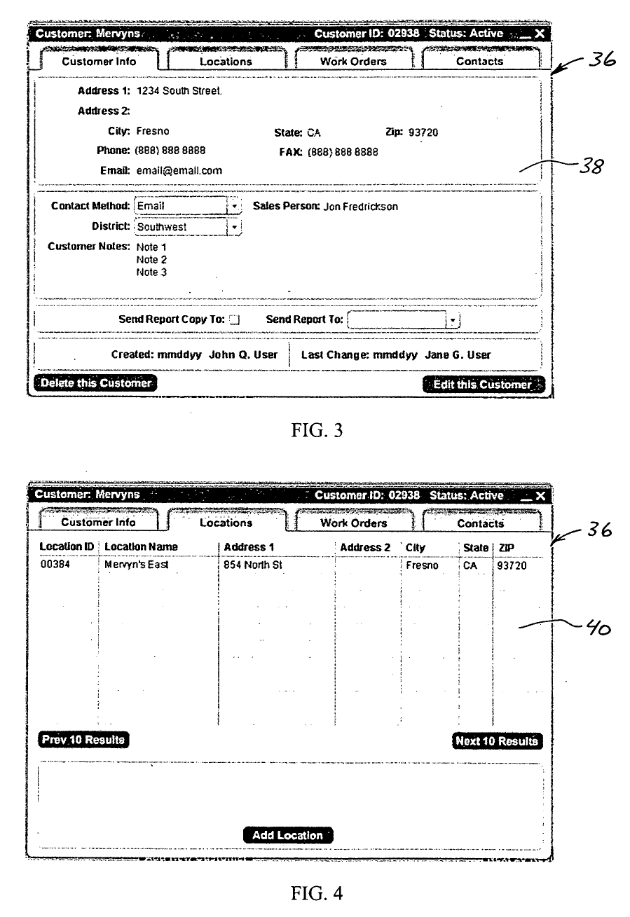

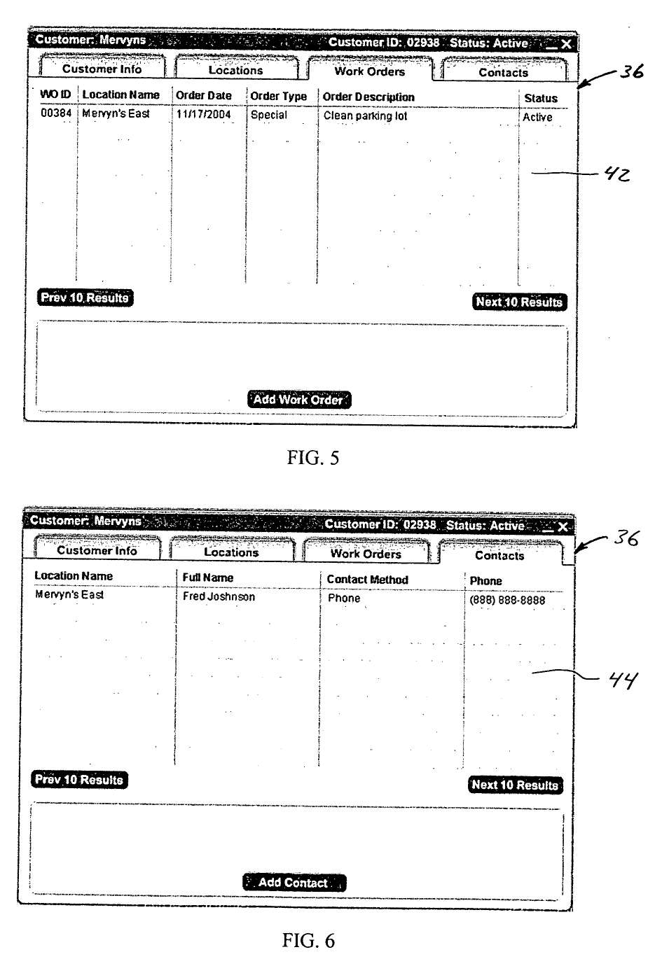

To utilize the method and system 10 of the present invention, it is necessary to have information pertaining to customer 12 and the services provided to it by cleaning services company 14. In one embodiment, a customer data form 36 consists of multiple input screens, as shown in FIGS. 3 through 6, including basic customer information screen 38 (FIG. 3), customer location screen 40 (FIG. 4), customer work order summary screen 42 (FIG. 5) and customer contacts screen 44 (FIG. 6). The customer information screen 38 includes basic address information, the customer's preferred method of contact, the salesperson of cleaning service company 14 associated with customer 12, the district in which the customer 12 is located and any miscellaneous notes that are relevant to customer 12. The customer's preferred method of contact, which is shown as email in FIG. 3, may be by telephone, cellular telephone, email, mail, in person or other methods of contact that may be applicable. In the embodiment shown, the district is a geographical region served by the franchise owner 24, franchisee 14 or a person/entity that is disposed between, with regard to management and control functions, the franchise owner 24 and the franchisee 14 that oversees one or more franchisees 14, such that franchisee 14 is more in the role of a sub-franchisee type of arrangement. Customer location screen 40, shown in FIG. 4, lists each location for the particular customer 12 where cleaning services are provided by cleaning services company 14. As shown, it may be beneficial to utilize location identification codes that are unique to each location. The customer work order summary screen 42, shown in FIG. 5, lists any work orders that are associated with the particular customer 12 by location. Customer work order summary screen 42 can also include work order identification numbers that are unique to the particular work order, a short summary of the work order and an indication of whether the work order is still in effect (i.e., active), completed or cancelled. Customer contacts screen 44, shown in FIG. 6, summarizes the contact person for each location where customer 12 is having cleaning services performed by cleaning services company 14. Customer contacts screen 44 provides a relatively quick and easy way to identify the person cleaning services company 14 needs to contact if they have any questions for customer 12. Generally, each contact for customer 12 will have a phone number where he or she can be reached. In addition, a contact for customer 12 may have a specific role, such as an emergency contact person.

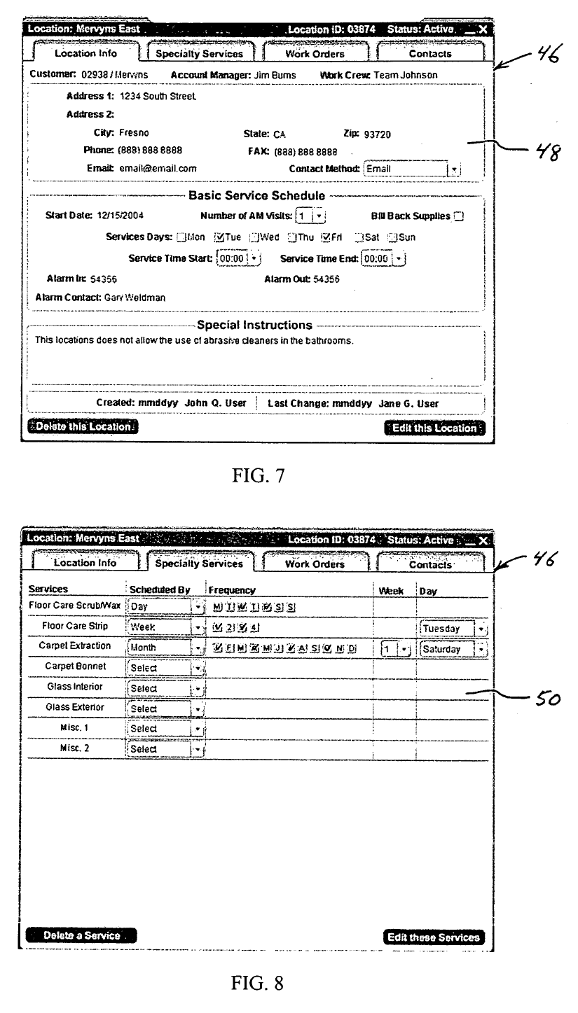

In addition to customer data, cleaning services company 12 and franchise owner 24 need more detailed information regarding the location or locations where cleaning services are provided by cleaning service company or franchisee 14. In one embodiment of the method and system 10 of the present invention, a location data form 46, shown in FIGS. 7 and 8, is used to enter and summarize information pertaining to these locations. As with the customer data form 36, location data form 46 comprises multiple screens to provide specific information regarding the locations of a particular customer 12. The location summary screen 48 identifies, by customer location, the specific location and the basic service schedule for that location, such as which days of the week the location is serviced, the time of day for that service, alarm codes, alarm contact person and any special instructions that pertain to that location. As set forth on the top of locations summary screen 48, the customer identification number, account manager 32 and work crew 34 is identified for that location. A specialty services screen 50 is utilized to identify any specialty services that are applicable to the customer's location, the frequency of providing that service (i.e., by day, week or month) and which day of the week or week of the month for the week or month frequency schedules, respectively. The work order and contacts screens for location data form 46 can comprise the same information set forth in the customer work order summary screen 42 and customer contacts screen 44 utilized for customer data form 36. Generally, customer data form 36 and location data form 46 are completed by account manager 32 associated with the particular customer 12 and/or customer location.

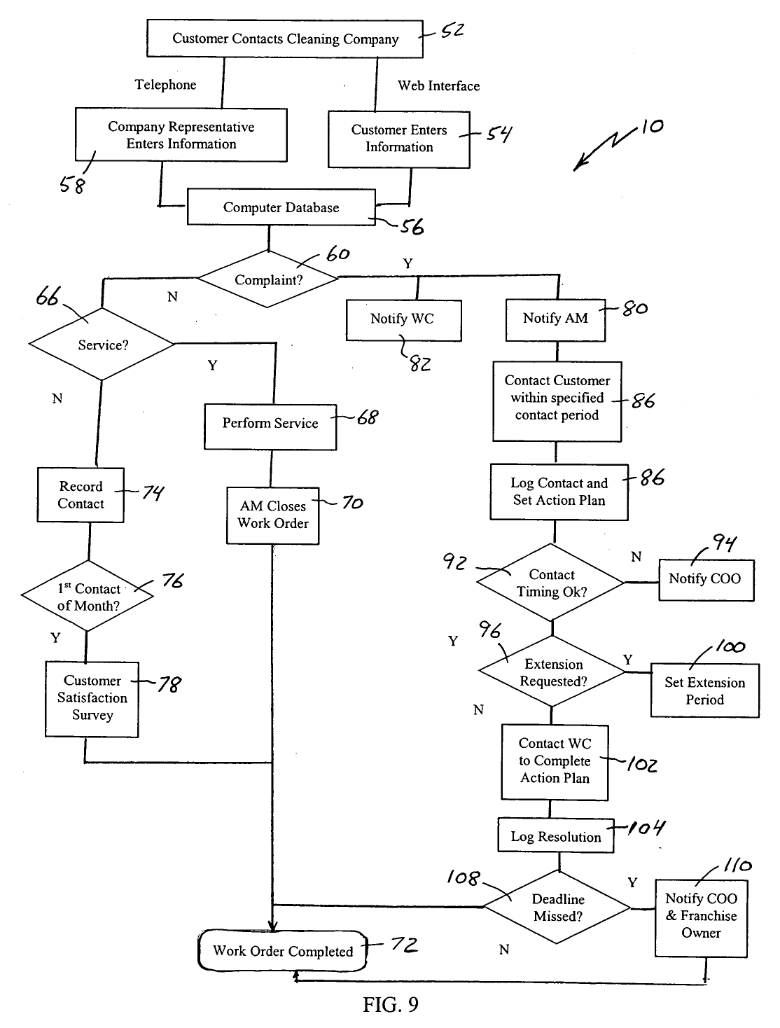

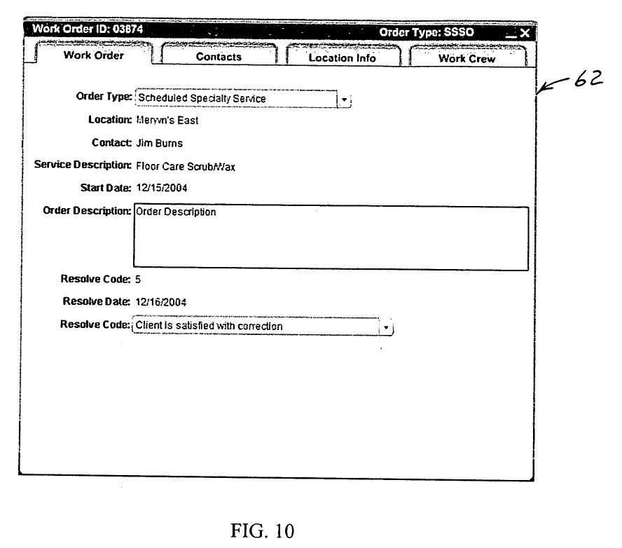

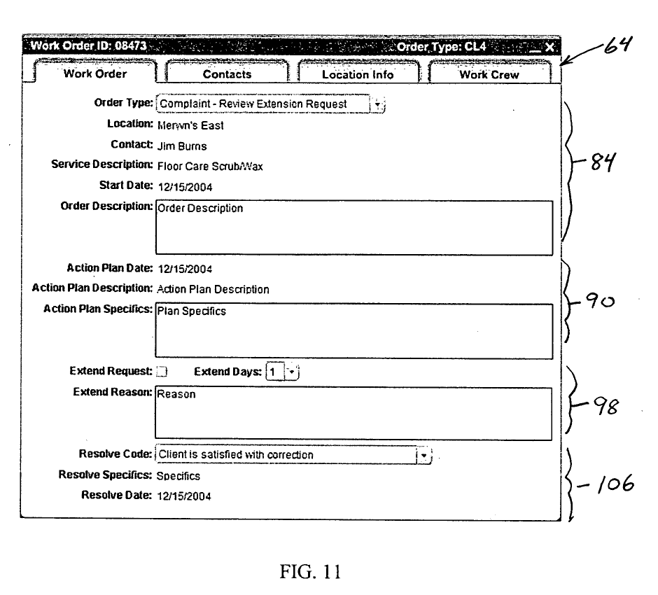

As best shown in FIGS. 1 and 9, when customer 12 desires to have cleaning services company 14 perform additional or special services or to register a complaint, it contacts cleaning services company 14 to start the procedures to perform the additional/special services or resolve the customer's complaint (shown as 52 in FIG. 9). In the preferred embodiment, customer 12 contacts cleaning services company 14 through a customer interface 54 via the Internet 18 or other online system to enter the information into the computer database 56 of cleaning services company 14 or franchise owner 24. As shown at 58 in FIGS. 1 and 9, alternatively customer 12 can also contact cleaning services company 14 by telephone or other non-online method to request additional or special services or to register a complaint. If the contact is made in the non-online manner, a representative of cleaning services company 14 enters the information into the computer database 56. In either circumstance, the customer information is used to generate a work order. For purposes of this disclosure, a work order is a general grouping of all interactions, including activities and communications, with customer 12 and includes requests for speciality and additional services and complaints. As shown at 60, the computer database distinguishes between those work order forms requesting additional or special services, an example of which is shown as 62 in FIG. 10, and those work order forms for lodging a complaint, an example of which is shown as 64 in FIG. 11, with regard to services performed or missed.

The information entered by the customer 12 in the customer interface 54 or by the company representative 58 will be segregated by the computer database 56 and generate a work order. As shown in FIG. 10, a typical work order form 62 seeking additional or special services will identify the type of work sought, such as additional services, scheduled specialty services or a customer proposal scope change (a scheduled speciality services order or SSSO is shown), the location, contact, type of service desired and a description of the order. If it is a service that is sought, as shown at 66, the work order 62 is transmitted to the work crew 34 to complete the requested work, shown as 68 in FIG. 9. As shown at 70, once the work is completed, the account manager 32 closes the work order 62 and the computer database 56 stores the information as completed, shown at 72. If the contact by customer 12 is neither a request for service nor a complaint, then the computer database records the contact, shown at 74, and determines whether this is the first contact of the month, shown at 76. If it is, the customer 12 is requested, at 78, to complete a customer satisfaction survey to indicate how he or she believes the service is being performed by cleaning services company 14. Information from any such surveys is used to keep a “real time” customer satisfaction indicator for use by cleaning services company 14 and franchise owner 24. Naturally, any lower survey marks should be addressed with the customer 12 to attempt to resolve any problems and improve the performance of cleaning services company 14.

If computer database 56 determines, at 60, that the work order form is a complaint (an example complaint work order form 64 is shown in FIG. 11), it is forwarded to the account manager 32 and work crew 34 assigned to that customer location, shown respectively as 80 and 82 in FIG. 9. An example of information entered into complaint work order form 64 by customer 12 is shown as 84 on form 64 shown in FIG. 11. In the preferred embodiment of the method and system 10 of the present invention, once the complaint information is entered into the system by the customer 12 via the customer interface 54 or by the company representative, at 58, it cannot be changed. The time and date of the lodging of the complaint is recorded by the computer database 56 and becomes part of the record associated with that complaint. Preferably, all dates and times are entered automatically based on the computer server's date and time (i.e., the central computer 26) in order to keep all times relative to the same calendar/clock and prevent users from manipulating response times. In one preferred embodiment of the present invention, the complaint resolution procedures are provided with an escalation or acceleration process, shown at 86 in FIG. 9, setting a time limit for the account manager 32 to respond back to customer 12, referred to as the customer contact period, and prepare an action plan to resolve the complaint, shown at 88 in FIG. 9, and a time limit to carry out the corrective action, referred to as the complaint resolution period. The customer contact and action plan can be entered into the complaint work order form 64 at 90 on FIG. 11. In one embodiment of the method and system 10 of the present invention, the customer contact period can be three hours and the complaint resolution period can be forty-eight hours. The actual amount of time should be chosen to reasonably reflect the ability of the employees of cleaning services company or franchisee 14 to respond and the expectations of customer 12, and should be reflected by the service level agreement (SLA) between the customer and the cleaning services company. As soon as the account manager 32 enters the contact and action plan information, the contact/action plan portion of the escalation clock stops and the elapsed time is recorded for later review or reporting. If the method and system 10 of the present invention is utilized with the escalation process, it can be an effective mechanism to ensure that customer complaints are quickly addressed and not put aside or forgotten. To further ensure that the company's goals and objectives with regard to customer complaints are followed, the method and system 10 can include programming that flags all complaint work orders 64 that have not had a response and action plan logged into the system within the preset customer contact period. As shown at 92, if the customer contact and action plan have not been logged in response to a customer complaint within the customer contact period, the computer system can be configured to automatically notify or report to one or more persons in a management position for cleaning services company 14, such as the chief operating officer 30 as shown at 94.

To allow for those times when it is neither possible nor practical to respond to the customer 12 and prepare an action plan within the customer contact period, the method and system of the present invention is provided with a mechanism for the account manager 32 to request extensions of time to respond, as shown at 96 on FIG. 9 and entered on the complaint work order form 64 at 98. The chief operating officer 30 or other responsible management person for cleaning services company 14 evaluates the request by account manager 32 for the extension of time, at 100 on FIG. 9, and determines if the extension of time is warranted, in which case he or she approves the request and sets an extension time in which to respond and prepare the action plan. If the requested extension is not warranted, the request is denied. Once the action plan is complete, account manager 32 contacts work crew 34 to carry out the action plan, shown at 102 on FIG. 9. As shown at 104, the resolution of the complaint, accomplished by carrying out the action plan, is entered on the complaint work order form 64 at 106 logged into computer database 56. At 108, the computer system determines if the complaint has been resolved within the period of time selected as the complaint resolution period plus any applicable, approved extension periods. If not, the system can be configured to automatically notify or report to one or more managers, such as the chief operating officer 30, the owner of cleaning services company 14 and franchise owner 24, as shown at 110. Preferably, the ability of the cleaning services company to meet the customer contact period and complaint resolution period deadlines is utilized to evaluate the performance of the personnel of cleaning services company 14 and of the company/franchisee 14 itself. As stated above, although it is not required to utilize these features to benefit from the method and system of the present invention, use of the customer contact period and complaint resolution features vastly improves the ability of franchise owner 24, the owner of cleaning services company 14 or other interested parties to oversee and control the cleaning services provided by cleaning services company 14, thereby improving the ability to protect and enhance the owner's brand and name recognition.

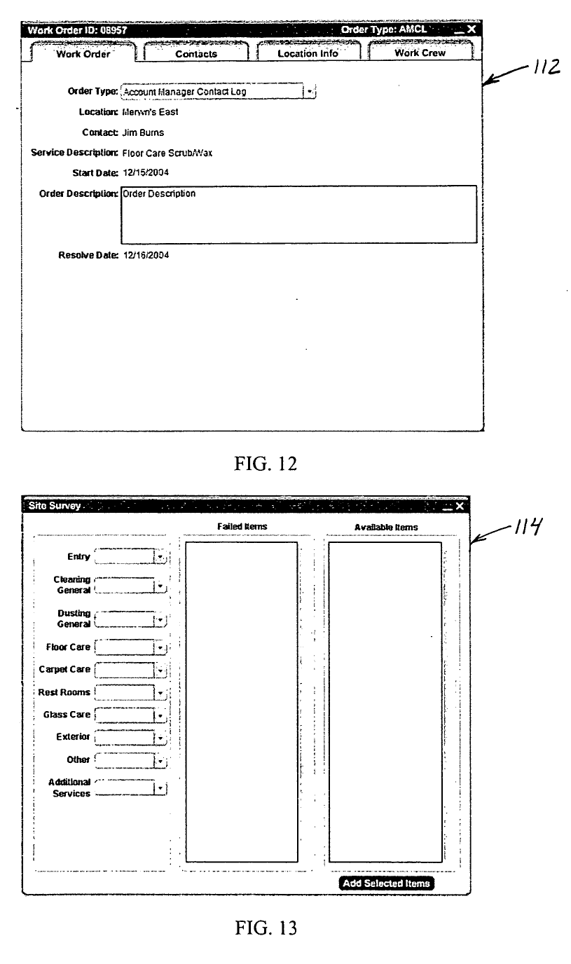

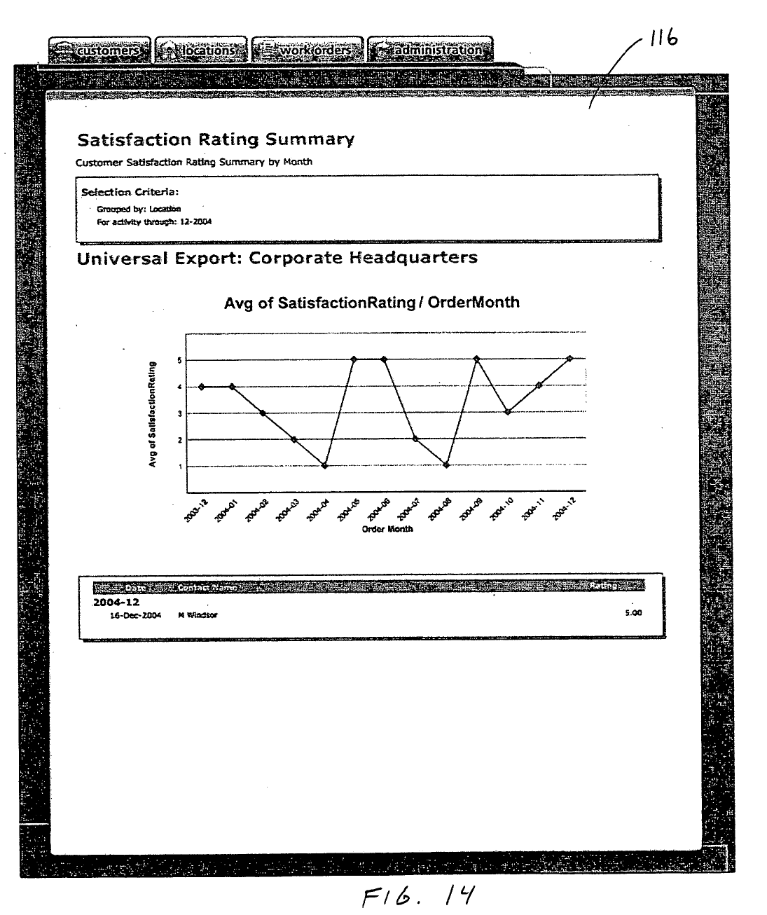

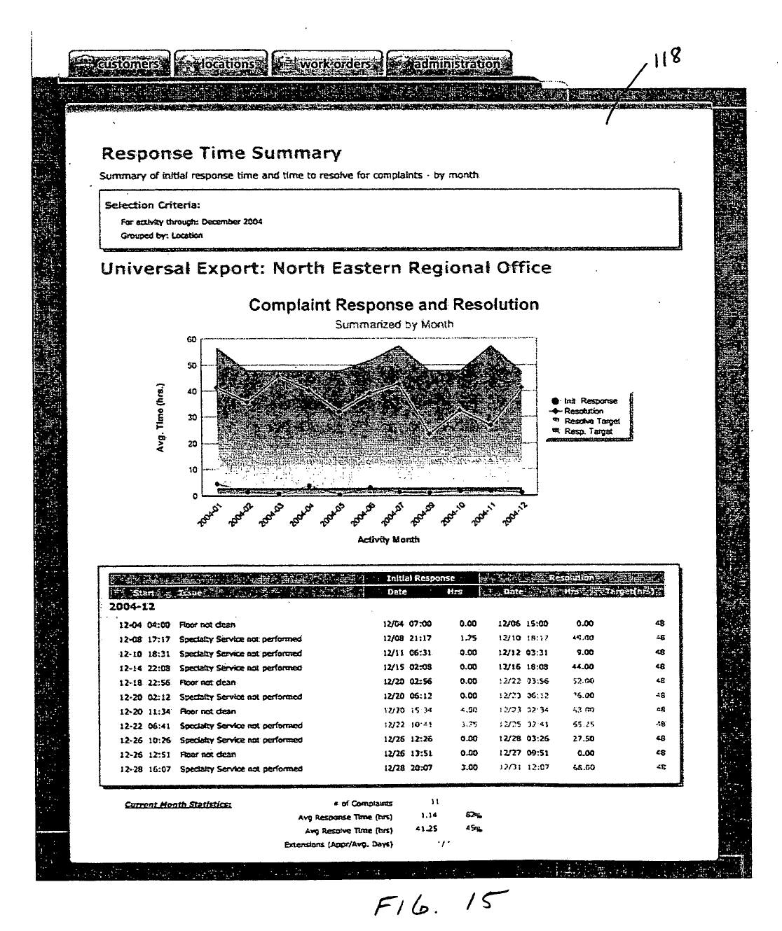

Various other forms are useful for obtaining the benefits of the method and system 10 for managing property cleaning services of the present invention. For instance, FIG. 12 is an account manager contact log 112 that is useful for recording the site visits by account manager 32. Preferably, each site visit includes a site survey form 114, shown in FIG. 13, which is used to review the property location where the services are provided and note any areas where improved services are needed (i.e., vacuuming or dusting not performed adequately). Also preferably, the first customer contact of each month by the account manage 32 will include a customer satisfaction survey, discussed above, to enable management to keep an ongoing determination of the general quality of services being provided to customers 12. FIG. 14 shows an example of a satisfaction report 116 that can be generated with this information to track the customer satisfaction information provided by the customer. As shown, this report can summarize the average satisfaction rating by month (or any other desired time period). The complaint report 118 shown in FIG. 15 summarizes the average amount of time, in hours, that it took to respond to and resolve customer complaints. As well known by those skilled in the art, various formats can be used for such reports. The report shown in FIG. 15 averages the information by month and also provides a detail listing, by month, of the various complaints, initial response time, actual resolution time and the target time.

From the foregoing, it can be determined that various benefits can be achieved by the method and system 10 of the present invention. Perhaps foremost among these benefits is an improved ability for the franchise owner 24 and the franchisee/business owner 14, and his or her management 30 and 32, to ensure a more effective and timely response to customer complaints or requests for additional services. The method and system of the present invention 10 facilitates reporting, analysis and action by the franchise owner 24 and others to protect and enhance the value of the franchise brand by reducing the number of unresolved or late resolved customer complaints and improve the cleaning company's response to requests for additional services. Ultimately, the use of the method and system 10 of the present invention may be able to reduce the number of customer complaints and improve the customer's satisfaction with the services provided under the brand.

While there are shown and described herein certain specific alternative forms of the invention, it will be readily apparent to those skilled in the art that the invention is not so limited, but is susceptible to various modifications and rearrangements in design and materials without departing from the spirit and scope of the invention. For instance, it should be noted that the present invention is subject to modification with regard to the configuration, layout and number of input screens and reports. In particular, the method and system of the present invention is adaptable to a wide variety of different reports that can be used to review and analyze the information set forth herein.

What is claimed is:

1. A cleaning services management method for managing one or more cleaning services provided to a customer by a cleaning services company, said method comprising the steps of:
a) providing a work order form for receiving a complaint from said customer, said work order form adapted for transmittal to a computer database in a central computer;
b) entering said complaint into said work order form and storing said work order form in said computer database;
c) transmitting said complaint by said central computer to one or more company personnel;
d) contacting said customer within a pre-selected customer contact period;
e) preparing an action plan to resolve said complaint; and
f) resolving said complaint within a pre-selected complaint resolution period.

2. The cleaning services management method of claim 1, wherein said one or more company personnel comprises an account manager and a work crew.

3. The cleaning services management method of claim 1 further comprising the step of notifying one or more managers of said company if said customer is not notified within said customer contact period after said customer contacting step.

4. The cleaning services management method of claim 3 further comprising the step of notifying said one or more managers if said complaint is not resolved within said complaint resolution period after said complaint resolution step.

5. The cleaning services management method of claim 4, wherein each of said notifying steps are automatically accomplished by said central computer.

6. The cleaning services management method of claim 1 further comprising the step of notifying one or more managers if said complaint is not resolved within said complaint resolution period after said complaint resolution step.

7. The cleaning services management method of claim 1, wherein each of said notifying steps are accomplished automatically by said central computer.

8. The cleaning services management method of claim 1, wherein said central computer is connected to a global information network.

9. The cleaning services management method of claim 1 further comprising the step of initiating a contact timer prior to said contacting step, said contact timer configured to track an actual contact time for at least one of said one or more company personnel to contact said customer.

10. The cleaning services management method of claim 1, wherein said work order form is cooperatively configured for receiving objective and subjective evaluations of service performance by providing a contact log to record a contact from said customer, a performance rating to record performance of the service by area or item and a customer satisfaction rating to record satisfaction of said customer.

11. The cleaning services management method of claim 1, wherein said work order form is cooperatively configured for receiving a services work order from said customer.

12. The cleaning services management method of claim 11, wherein said work order form allows said customer to request one or more additional services and/or one or more special services.

13. The cleaning services management method of claim 12, wherein at least one of said one or more company personnel completes said additional service and/or said special service and enters a work completed report into said computer database.

14. The cleaning services management method of claim 1, wherein said cleaning service company is a franchisee in a franchise organization managed by a franchise owner, said computer database accessible by said franchise owner.

15. A cleaning services management method for managing one or more cleaning services provided to a customer by a cleaning services company, said method comprising the steps of:
a) providing a work order form for receiving a complaint from said customer, said work order form adapted for transmittal to a computer database in a central computer connected to a global information network;
b) entering said complaint into said work order form and storing said work order form in said computer database;
c) transmitting said complaint by said central computer to one or more company personnel;
d) contacting said customer within a customer contact period;
e) notifying one or more managers of said company if said customer is not notified within said customer contact period;
f) preparing an action plan to resolve said complaint;
g) resolving said complaint within a complaint resolution period; and
h) notifying said one or more managers if said complaint is not resolved within said complaint resolution period.

16. The cleaning services management method of claim 15, wherein each of said notifying steps are automatically accomplished by said central computer.

17. The cleaning services management method of claim 15, wherein said cleaning service company is a franchisee in a franchise organization managed by a franchise owner, said computer database accessible by said franchise owner.

18. The cleaning services management method of claim 17, wherein said one or more notifying steps also notifies said franchise owner.

19. A cleaning services management system for managing one or more cleaning services provided to a customer by a cleaning services company, said system comprising:
a central computer;
a computer database associated with said central computer for receiving a complaint generated by said customer and transmitting said complaint to one or more company personnel;
a complaint report corresponding to said complaint, said complaint report prepared from data entered by at least one of said customer and said cleaning service company, said complaint report transmitted to at least one of said one or more company personnel;
a contact verification report prepared by at least one of said one or more company personnel after contacting said customer regarding said complaint;
an action plan interconnected to said computer database prepared by said company personnel to resolve said complaint;
a resolution confirmation report interconnected to said computer database to confirm that said complaint is addressed by said company personnel; and
a manager oversight report interconnected to said computer database to notify a manager of said cleaning services company of the status of said complaint, said manager oversight report configured to automatically notify said manager if said contact verification report is not prepared within a customer contact period and/or if said resolution confirmation report is not accomplished within a complaint resolution period.

20. The cleaning services management system of claim 19, wherein said complaint report, contact verification report, action plan and resolution confirmation report are merged into a management report.

21. The cleaning services management system of claim 20, wherein said cleaning service company is a franchisee in a franchise organization managed by a franchise owner, said computer database accessible by said franchise owner.
